(19) United States
(12) Patent Application Publication
(10) Pub. No.: US 2006/0075471 A1
(43) Pub. Date: Apr. 6, 2006

(54) Authentication method, authentication apparatus and computer-readable storage medium

(75) Inventors: Masaharu Minowa, Kawasaki (JP); Masaki Mukouchi, Kawasaki (JP); Makoto Sugimoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/285,205

(22) Filed: Nov. 23, 2005

Related U.S. Application Data
(63) Continuation of application No. PCT/JP03/09664, filed on Jul. 30, 2003.

(51) Int. Cl. H04L 9/32

(52) U.S. Cl. 726/2

(57) ABSTRACT

An authentication method makes a personal identification when a plurality of operation target regions corresponding to a personal identification code are operated in a predetermined sequence. The authentication method judges whether or not a predetermined operation target region that is preset is operated in a preset operation direction or a preset operation angle, and confirms the personal identification based on a judgement result.

This application is a continuation application filed under 35 U.S.C. 111(a) claiming the benefit under 35 U.S.C. 120 and 365(c) of a PCT International Application No. PCT/JP2003/009664 filed Jul. 30, 2003, in the Japanese Patent Office, the disclosure of which is hereby incorporated by reference.

### BACKGROUND OF THE INVENTION

1. Field of the Invention

The present invention generally relates to authentication methods, authentication apparatuses and computer-readable storage media, and more particularly to an authentication method and an authentication apparatus for making a personal identification based on input of a personal identification number or the like, and to a computer-readable storage medium which stores a program for causing a computer to make a personal identification by such an authentication method.

In automatic teller machine (ATM) terminals of banks, access systems to computers, locking systems at entrances and exits of research centers, and the like, it is necessary to make a personal identification to ensure security. As one authentication method for making the personal identification, there is a method which makes the personal identification based on the input of the personal identification number or the like.

2. Description of the Related Art

For example, the authentication method employed in the general ATM terminal of the bank requires the user to insert a card into the ATM terminal and to thereafter input the personal identification number of the user. The ATM terminal makes the personal identification based on the input personal identification number, and if the personal identification is correctly made, a screen is displayed to enable a bank transaction desired by the user. For example, the personal identification number consists of four digits, and the personal identification is made depending on whether or not the numerals of the four digits are input in the correct sequence.

However, in the general ATM terminal of the bank, an operation panel is formed by a touch panel, and the input of the personal identification number and the selection of the desired bank transaction are made when the user touches various buttons that are displayed on the touch panel. For this reason, when the user is inputting the personal identification number, there is a possibility of the numerals that are input and the input sequence of the numerals being seen by a third party. If the personal identification number of the user leaks to the third party and card information of the user leaks to the third party by some method, there was a problem in that there is a danger of illegal use of the card.

A problem similar to the above problem encountered in the ATM terminal of the bank are also encountered in the access system to the computer, the locking system at the entrance and exit of the research center, and the like. In addition, since the access system to the computer, the locking system and the like may not require the user to insert a card, and may make the personal identification based on an employee code of the user that is input and the personal identification number of the user that is input, for example, there was a problem in that the leak of the personal identification number to the third party will directly result in deterioration of the security.

In order to improve the security, it is conceivable to increase the number of digits of the personal identification number, carry out the authentication in two stages using two kinds of personal identification numbers, and additionally employ another kind of authentication method such as a finger print authentication method, for example. However, according to these conceivable methods, there was a problem in that the operation required of the user becomes complex and the load on the user increases.

The applicants are aware of the following prior art.

Japanese Laid-Open Patent Application No. 2002-055781

Japanese Laid-Utility Model Application No. 5-036623

Japanese Laid-Open Patent Application No. 10-269021

Japanese Laid-Open Patent Application No. 5-250094

### SUMMARY OF THE INVENTION

Accordingly, it is a general object of the present invention to provide a novel and useful authentication method, authentication apparatus and computer-readable storage medium, in which the problems described above are suppressed.

Another and more specific object of the present invention is to provide an authentication method, an authentication apparatus and a computer-readable storage medium, which can improve the security by a relatively simple operation.

Still another object of the present invention is to provide an authentication method for making a personal identification when a plurality of operation target regions corresponding to a personal identification code are operated in a predetermined sequence, comprising a judging step judging whether or not a predetermined operation target region that is preset is operated in a preset operation direction or a preset operation angle; and a confirming step confirming the personal identification based on a judgement result of the judging step. According to the authentication method of the present invention, it is possible to improve the security by a relatively simple operation.

A further object of the present invention is to provide an authentication apparatus for making a personal identification when a plurality of operation target regions corresponding to a personal identification code are operated in a predetermined sequence, comprising a judging part configured to judge whether or not a predetermined operation target region that is preset is operated in a preset operation direction or a preset operation angle; and a confirming part configured to confirm the personal identification based on a judgement result of the judging part. According to the authentication apparatus of the present invention, it is possible to improve the security by a relatively simple operation.

Another object of the present invention is to provide a computer-readable storage medium which stores a computer program for causing a computer to make a personal identification when a plurality of operation target regions corresponding to a personal identification code are operated in a predetermined sequence, the computer program comprising a judging procedure causing the computer to judge whether or not a predetermined operation target region that is preset is operated in a preset operation direction or a preset operation angle; and a confirming procedure causing the computer to confirm the personal identification based on a judgement result of the judging procedure. According to the computer-readable storage medium of the present invention, it is possible to improve the security by a relatively simple operation.

Other objects and further features of the present invention will be apparent from the following detailed description when read in conjunction with the accompanying drawings.

### BRIEF DESCRIPTION OF THE DRAWINGS

FIG. 1 is a system block diagram showing a first embodiment of the authentication apparatus according to the present invention;

FIG. 2 is a flow chart for explaining an operation of the first embodiment;

FIG. 3 is a diagram for explaining a button operation in which the user slides a finger on a button;

FIG. 4 is a flow chart for explaining a first slide direction detection process;

FIG. 5 is a diagram for explaining a slide direction of the user's finger with respect to the button;

FIG. 6 is a diagram for explaining the slide direction of the user's finger with respect to the button;

FIG. 7 is a flow chart for explaining a second slide direction detection process;

FIG. 8 is a diagram for explaining two slide directions of the user's finger with respect to the button;

FIG. 9 is a diagram for explaining the two slide directions of the user's finger with respect to the button;

FIG. 10 is a diagram for explaining the two slide directions of the user's finger with respect to the button;

FIG. 11 is a flow chart for explaining a slide angle detecting process;

FIG. 12 is a diagram for explaining a slide angle of the user's finger with respect to the button;

FIG. 13 is a diagram for explaining a button layout suited for the slide operation of the button;

FIG. 14 is a diagram for explaining the button layout suited for the slide operation of the button;

FIG. 15 is a diagram for explaining the button layout suited for the slide operation of the button;

FIG. 16 is a diagram for explaining the button layout suited for the slide operation of the button;

FIG. 17 is a system block diagram showing a second embodiment of the authentication apparatus according to the present invention;

FIG. 18 is a diagram for explaining a case where a button is traced by a cursor;

FIG. 19 is a diagram for explaining the case where the button is traced by the cursor;

FIG. 20 is a diagram for explaining the case where the button is traced by the cursor;

FIG. 21 is a diagram for explaining the case where the button is traced by the cursor;

FIG. 22 is a diagram for explaining the case where the button is traced by the cursor;

FIG. 23 is a diagram for explaining the case where the button is traced by the cursor;

FIG. 24 is a diagram for explaining a case where an operation direction of a button is determined by a drag-and-drop operation; and

FIG. 25 is a diagram for explaining the case where the operation direction of the button is determined by the drag-and-drop operation.

### DESCRIPTION OF THE PREFERRED EMBODIMENTS

A description will be given of embodiments of the authentication method, the authentication apparatus and the computer-readable storage medium according to the present invention, by referring to the drawings.

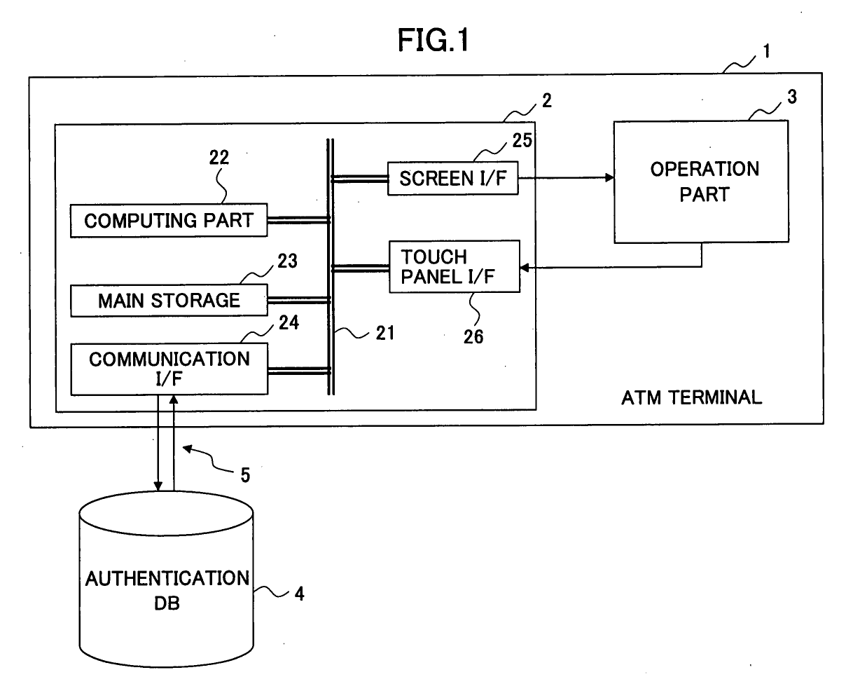

FIG. 1 is a system block diagram showing a first embodiment of the authentication apparatus according to the present invention. This first embodiment of the authentication apparatus employs a first embodiment of the authentication method according to the present invention and a first embodiment of the computer-readable storage medium according to the present invention. In this first embodiment of the authentication apparatus, the present invention is applied to an ATM terminal.

An ATM terminal 1 shown in FIG. 1 includes a main part 1 and an operation part 3, and is connected to an authentication database (DB) 4. The main part 2 includes a computing part (or a processing part) 22, a main storage part 23, a communication interface (I/F) 24, a screen interface (I/F) 25 and a touch panel interface (I/F) 26 that are connected via a bus 21. The operation part 3 is formed by a touch panel having a known structure that integrally comprises a display panel and an operation panel. The computing part 22 is formed by a processor such as a CPU, and controls the operation of the entire ATM terminal 1. The main storage part 23 is formed by a storage unit such as a RAM, a ROM and/or a disk unit, and stores computer programs that are executed by the computing part 22, intermediate data of computations carried out by the computing part 22, and the like. The communication I/F 24 is connected to the authentication database 4 via a communication line 5, under the control of the computing part 22. User information (registered user information) including information related to personal identification numbers is registered in advance in the authentication database 4. The communication line 5 is formed by a cable network and/or a wireless network. The screen I/F 25 outputs information that is to be displayed on the display panel to the display panel of the operation part 3, under the control of the computing part 22. The touch panel I/F 26 inputs to the computing part 22 information that is input from the operation panel of operation part 3.

The internal structure itself of the ATM terminal 1 shown in FIG. 1 may be realized by a known structure or, by a structure of a known computer.

The ATM terminal 1 is provided with a card inserting opening through which the user's card is inserted into the ATM terminal 1, and a card reader for reading user information and the like recorded on the inserted card. However, the illustration and description of the card inserting opening and the card reader will be omitted in this specification, since known structures may be user for both the card inserting opening and the card reader. Accordingly, a description of a user operation when the user inserts the card into the card inserting opening and a corresponding operation of the ATM terminal 1, and an operation of the ATM terminal 1 when the card reader recognizes the information recorded on the card, will be omitted in this specification.

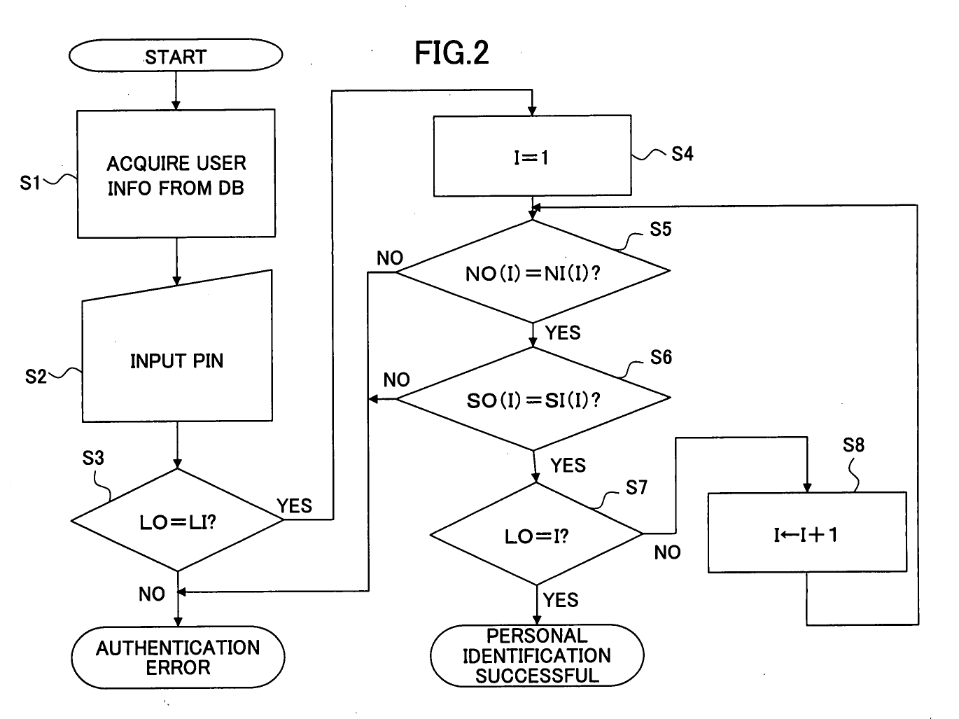

FIG. 2 is a flow chart for explaining an operation of the first embodiment. The process shown in FIG. 2 is carried out by the computing part 22 shown in FIG. 1.

The process shown in FIG. 2 is started when the user inserts the card into the card inserting opening, the card reader reads-the user information and the like from the inserted card, and the user information is recognized. Of course, the user information may be input to the ATM terminal 1 based on other than the card. For example, the user may input the user information from the operation panel of the operation part 3. A step S1 makes access to the authentication database 4 based on the recognized user information, and acquires the registered user information such as a number of digits LO of the personal identification number, numerals NO(1) through NO(LI) of each of the digits of the personal identification number, and slide directions SO(1) through SO(LI). The slide direction indicates a direction in which the user slides his finger on the button, when selecting the button of the numeral of each digit of the personal identification number on the display panel of the operation part 3. A step S2 displays a message on the display panel of the operation part 3 to urge the user to input the personal identification number, and the user inputs the personal identification number from the operation panel of the operation part 3. In this embodiment, the step S2 acquires a number of digits LI of the input personal identification number, numerals NI(1) through NI(LI) of each of the digits of the personal identification number, and slide directions SI(1) through SI(LI).

A step S3 decides whether or not the number of digits LI of the input personal identification number matches the number of digits LO of the registered personal identification number, and a generation of an authentication error is recognized if the decision result in the step S3 is NO. If the generation of the authentication error is recognized, a known error process, such as displaying an error message on the display panel of the operation part 3, for example, is carried out. On the other hand, if the decision result in the step S3 is YES, a step S4 initializes an index value I of a matching process to I=1.

A step S5 decides whether or not the numeral NI(I) of the digit of the input personal identification number matches the numeral NO(I) of the corresponding digit of the registered personal identification number, and a generation of an authentication error is recognized if the decision result in the step S5 is NO. If the decision result in the step S5 is YES, a step S6 decides whether or not the slide direction SI(I) of the numeral NI(I) of the digit of the input personal identification number matches the slide direction SO(I) of the numeral NO(I) of the corresponding digit of the registered personal identification number by carrying out a matching process, and a generation of an authentication error is recognized if the decision result in the step S6 is NO. If the decision result in the step S6 is YES, a step S7 decides whether or not the matching process described above has been completed for all of the number of digits LO=I of the registered personal identification number. If the decision result in the step S7 is NO, a step S8 increments the index I of the matching process by 1 to I=I+1, and the process returns to the step S5. On the other hand, if the decision result in the step S7 is YES, the input user information matches the registered user information, and the personal identification of the user is recognized. When the personal identification of the user is recognized, the screen for selecting the bank transaction desired by the user is displayed on the display panel of the operation part 3, for example, so as to permit the user to make a bank transaction.

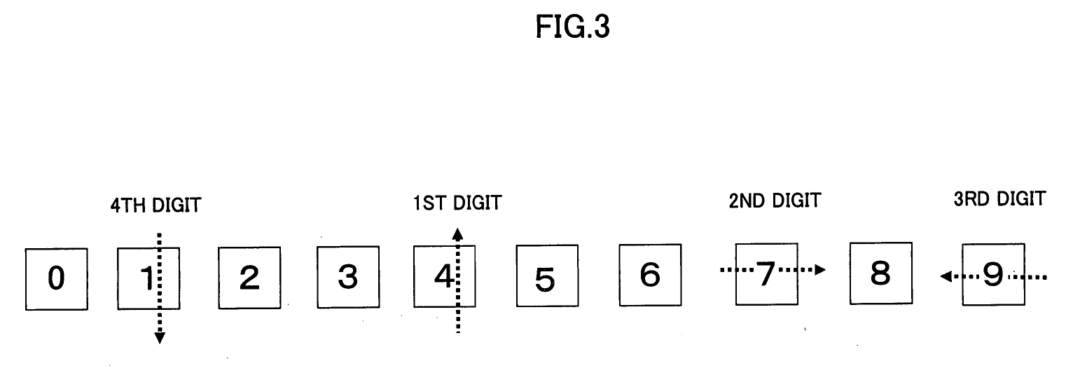

FIG. 3 is a diagram for explaining a button operation (or slide operation) in which the user slides a finger on a button, when selecting the button of the numeral of each digit of the personal identification number on the display panel of the operation part 3. FIG. 3 shows a state where the buttons of the numerals “0” through “9” are displayed on the display panel of the operation part 3, and in this particular case, it is assumed for the sake of convenience that the personal identification number is “4791”. Furthermore, it is assumed for the sake of convenience that the slide directions are from the bottom to top (bottom-to-top direction) for the button of the numeral “4” of the first digit of the personal identification number, from the left to right (left-to-right direction) for the button of the numeral “7” of the second digit of the personal identification number, from the right to left (right-to-left direction) for the button of the numeral “9” of the third digit of the personal identification number, and from the top to bottom (top-to-bottom direction) for the button of the numeral “1” of the fourth digit of the personal identification number. Of course, the personal identification number may include the same numeral for a plurality of digits thereof.

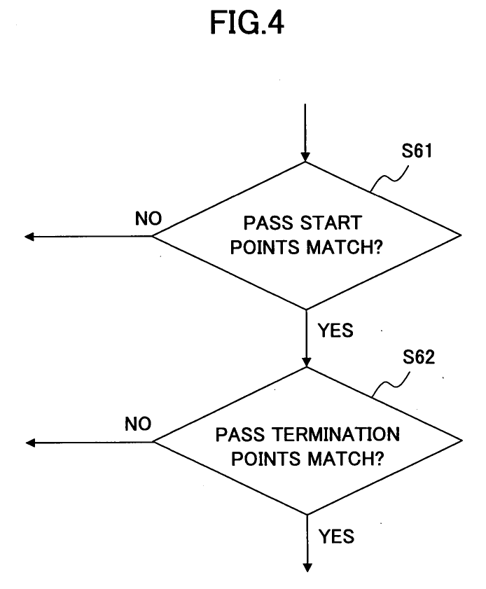

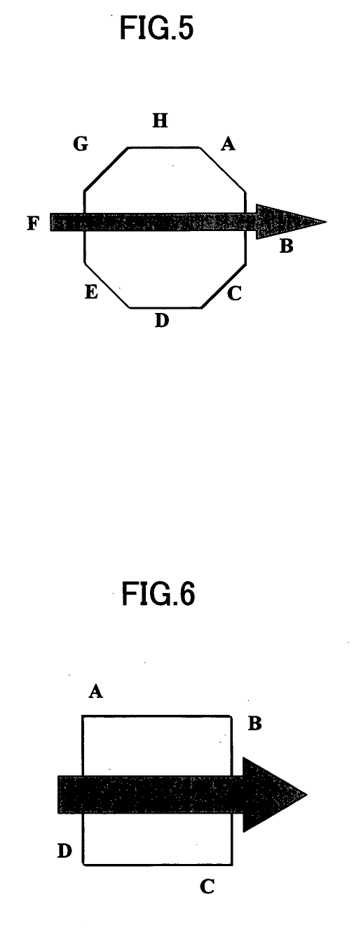

FIG. 4 is a flow chart for explaining a first slide direction detection process that detects a single slide direction of the user's finger with respect to the button. The single slide direction means that, in one slide operation of the user's finger with respect to the button, the finger slides in a single direction and the slide direction does not change during the slide operation. The process shown in FIG. 4 is carried out when carrying out the step S6 shown in FIG. 2. In addition, FIG. 5 is a diagram for explaining the slide direction of the user's finger with respect to the button.

In FIG. 4, a step S61 decides whether or not a pass start point SS(I) where the user's finger first passes a side of the button of a certain digit of the personal identification number matches a pass start point SSr(I) that is registered in the authentication database 4 with respect to the same digit, by carrying out a matching process.

FIG. 5 shows a case where the slide direction with respect to each digit of the personal identification number can be selected and registered from 16 slide directions. In other words, it is assumed for the sake of convenience that the pass start point SSr(I) and a pass termination point STr(I) can be registered for 16 slide directions, with respect to a virtual octagon for slide direction detection having 8 sides A through H. FIG. 5 shows a case where the slide direction with respect to the second digit of the personal identification number is from the left to right as shown in FIG. 3, and in this case, the pass start point SSr(I)=F and the pass termination point STr(I)=B are registered. Accordingly, in this particular case, the step S61 decides whether or not the actual pass start point SS(I) matches the registered pass start point SSr(I)=F. If the decision result in the step S61 is NO, the decision result of the step S6 shown in FIG. 2 becomes NO.

If the decision result in the step S61 is YES, a step S62 decides whether or not a pass termination point ST(I) where the user's finger last passes a side of the button of a certain digit of the personal identification number matches the pass termination point STr(I) that is registered in the authentication database 4 with respect to the same digit, by carrying out a matching process. In the case shown in FIG. 5, the pass termination point STr(I)=B is registered, as described above. Accordingly, in this particular case, the step S62 decides whether or not the actual pass termination point ST(I) matches the registered pass termination point STr(I)=B. If the decision result in the step S62 is NO, the decision result in the step S6 shown in FIG. 2 becomes NO. On the other hand, if the decision result in the step S62 is YES, the decision result in the step S6 shown in FIG. 2 becomes YES.

The number of slide directions that may be registered for each digit of the personal identification number is of course not limited to 16 as in the case shown in FIG. 5. For example, the pass start point SSr and a pass termination point STr can be registered for 8 slide directions, with respect to a virtual rectangle for slide direction detection having 4 sides A through D as shown in FIG. 6. FIG. 6 is a diagram for explaining the slide direction of the user's finger with respect to the button. In the case where the slide direction with respect to the second digit of the personal identification number is from the left to right as shown in FIG. 3, a pass start point SSr=D and a pass termination point STr=B are registered in the case shown in FIG. 6. All that is required is for the slide direction to be selectable from a plurality of slide directions and registrable, with respect to each digit of the personal identification number. In addition, the virtual shape for the slide direction detection that is used to register the pass start point SSr and the pass termination point STr may be any arbitrary polygonal shape, such as a triangle and a rectangle. Furthermore, although the virtual shape for the slide direction detection and the shape of the actual button do not necessarily have to match, it is desirable that the two have the same shape when taking into consideration the ease with which the user may make the slide operation. It is desirable that the shape of the actual button inscribes the virtual shape for the slide direction detection or, has a size accommodatable within the virtual shape for the slide direction detection.

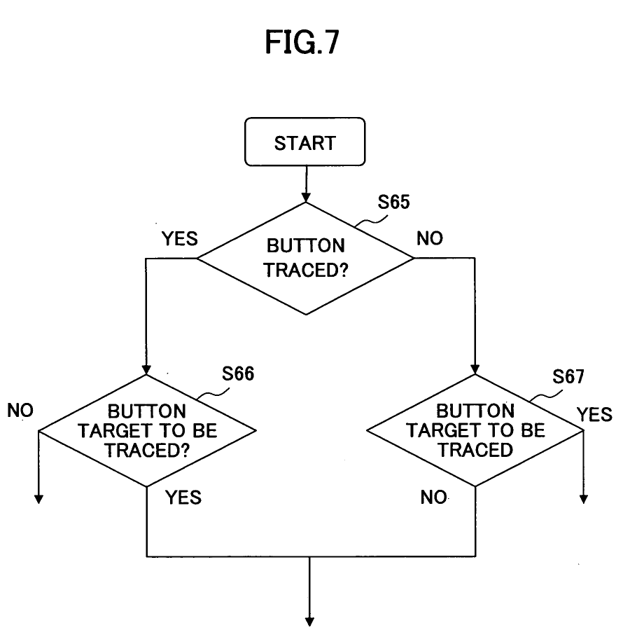

In the embodiment described above, it is assumed for the sake of convenience that the slide direction is registered with respect to each digit of the personal identification number. However, the slide direction may only be registered with respect to one or a plurality of specific digits of the personal identification number. FIG. 7 is a flow chart for explaining a second slide direction detection process for detecting the single slide direction of the user's finger with respect to the button in such a case. The process shown in FIG. 7 is carried out when carrying out the step S6 shown in FIG. 2.

In FIG. 7, a step S65 decides whether or not the button is traced (that is, a slide operation has been made with respect to the button), by detecting the pass start point SS(I) where the user's finger first passes the side of the button of a certain digit of the personal identification number and the pass termination point ST(I) where the user's finger last passes the side of the button of the certain digit of the personal identification number. If the decision result in the step S65 is YES, a step S66 decides whether or not the button that is traced is registered in advance in the authentication database 4 as a digit that is to be traced. If the decision result in the step S66 is NO, the decision result in the step S6 shown in FIG. 2 becomes NO. On the other hand, the decision result in the step S6 shown in FIG. 2 becomes YES if the decision result in the step S66 is YES.

If the decision result in the step S65 is NO, a step S67 decides whether or not the button that is traced is registered in advance in the authentication database 4 as a digit that is to be traced. If the decision result in the step S67 is YES, the decision result in the step S6 shown in FIG. 2 becomes NO. On the other hand, the decision result in the step S6 shown in FIG. 2 becomes YES if the decision result in the step S67 is NO.

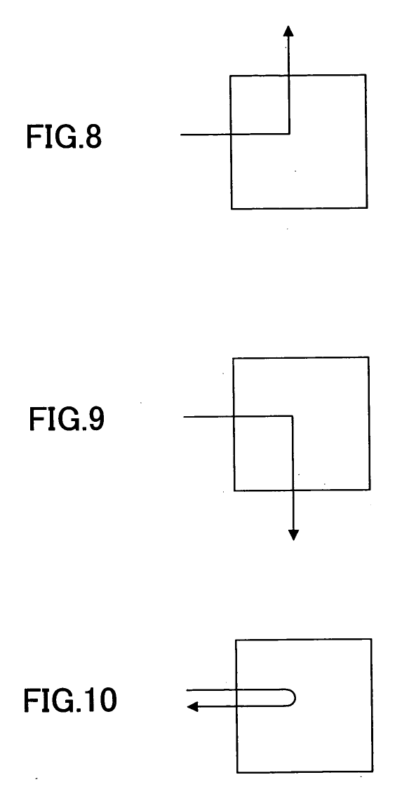

Next, a description will be given of a third slide direction detection process for detecting the slide direction of the user's finger with respect to the button, by referring to FIGS. 8 through 10. FIGS. 8 through 10 respectively are diagrams for explaining two slide directions of the user's finger with respect to the button.

In the embodiment described above, the pass start point SSr where the user's finger is to first pass the side of the button of the certain digit of the personal identification number and the pass termination point STr where the user's finger is to last pass the side of the button of the certain digit of the personal identification number are located at the two confronting sides of the virtual shape for the slide direction detection. Accordingly, if the virtual shape for the slide direction detection is a rectangle, SSr=D and STr=B as shown in FIG. 6. However, the pass start point SSr and the pass termination point STr do not necessarily have to be located on the two confronting sides of the virtual shape for the slide direction detection. In other words, the slide direction may include two directions instead of only one direction. In the case where the slide direction includes two directions, the user changes the slide direction of the user's finger inside the button.

FIG. 8 shows a case where SSR=D and STr=A, and the slide operation is made from outside the button to inside the button from the left to right, and the slide direction is changed inside the button and the slide operation is made from inside the button to outside the button in the upward direction. In this case, “outside the button” refers to a region on an outer peripheral portion of the button, and “inside the button” refers to a region inside the button. FIG. 9 shows a case where SSr=D and STr=C, and the slide operation is made from outside the button to inside the button from the left to right, and the slide direction is changed inside the button and the slide operation is made from inside the button to outside the button in the downward direction. FIG. 10 shows a case where SSr=D and STr=D, and the slide operation is made from outside the button to inside the button from the left to right, and the slide direction is changed inside the button and the slide operation is made from inside the button to outside the button in the leftward direction.

By appropriately setting the pass start point SSr and the pass termination point STr that are to be registered in advance, it is possible to also cope with the case where the slide direction includes two directions, by carrying out a process similar to that described above with reference to FIG. 4 or FIG. 7.

According to the first through third slide direction detection processes described above, the user makes the slide operation by sliding the user's finger from “outside the button”→“inside the button”→“outside the button”. However, it is possible to detect only one of the pass start point SS and the pass termination point ST.

According to a fourth slide direction detection process, only the pass start point SSr is registered in advance. Hence, when the user makes the slide operation by sliding the user's finger from “outside the button”→“inside the button”, the pass start point SS is matched with the corresponding pass start point SSr that is registered in advance. In this case, the step S62 shown in FIG. 4 may be omitted. In addition, since it is sufficient to detect the pass start point SS, the user may make the slide operation by sliding the user's finger from “outside the button”→“inside the button”→“outside the button”, and the slide operation does not necessarily have to end inside the button.

According to a fifth slide direction detection process, only the pass termination point STr is registered in advance. Hence, when the user makes the slide operation by sliding the user's finger from “inside the button”→“outside the button”, the pass termination point SR is matched with the corresponding pass termination point STr that is registered in advance. In this case, the step S61 shown in FIG. 4 may be omitted. In addition, since it is sufficient to detect the pass termination point ST, the user may make the slide operation by sliding the user's finger from “outside the button”→“inside the button”→“outside the button”, and the slide operation does not necessarily have to start inside the button.

In general, the user is familiar with pushing a button, but is not familiar with making the slide operation by sliding the user's finger from outside the button to inside the button. Hence, by making the size of the button sufficiently large with respect to the average size of the finger tip (for example, finger tip of the index or middle finger) of adults, the slide operation from “inside the button”→“outside the button” can be made by pushing the button by the operator's finger and then sliding this finger on the button in a predetermined direction, thereby making it possible even for a user who is unfamiliar with the slide operation to easily make the slide operation.

Moreover, in the case where the size of the button is set sufficiently large with respect to the average size of the finger tip of adults, the size of the virtual shape for the slide direction detection may be set small compared to that of the button, so that the slide direction can be detected from the slide direction inside the button.

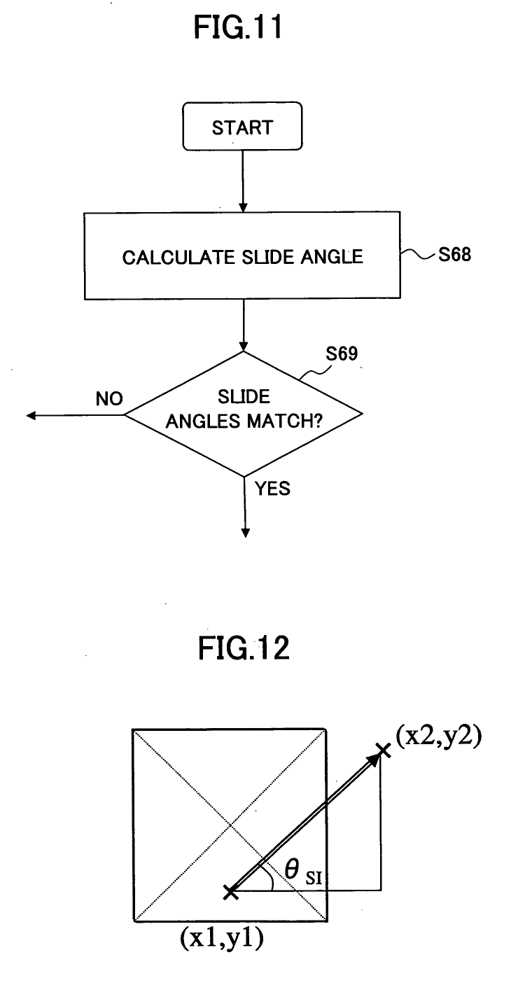

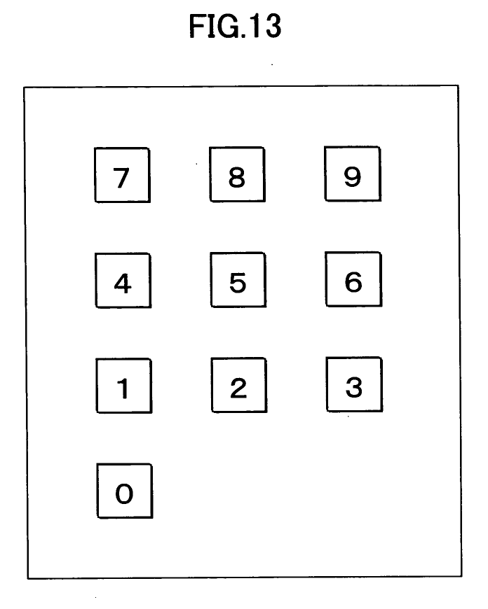

According to the first through fifth slide direction detection processes, the slide direction is detected by detecting the pass start point SS and/or the pass termination point St of the user's finger with respect to the button. Next, a description will be given of a process of detecting a slide angle of the user's finger with respect to the button, by referring to FIGS. 11 and 12. FIG. 11 is a flow chart for explaining a slide angle detecting process. Further, FIG. 12 is a diagram for explaining the slide angle of the user's finger with respect to the button.

In this case, in the step S1 shown in FIG. 2, it is assumed for the sake of convenience that slide angles θ_{SO}(1) through θ_{So}(LI) and a tolerable error θt are registered in the authentication database 4 in place of the slide directions SO(1) through SO(LI), and in the step S2 shown in FIG. 2, it is assumed for the sake of convenience that contact start positions Ss(1) through Ss(LI) and contact termination positions St(1) through St(LI) are input in place of the slide directions SI(1) through SI(LI). The slide angle refers to an angle that is formed by a straight line connecting a contact start position where the user's finger starts to contact (or touch) the operation panel of the operation part 3 and a contact termination position where the user's finger was contacting (or touching) immediately before terminating contact with (or separating from) the operation panel of the operation part 3, and a reference straight line. If the contact start position is outside the button, the contact termination position is inside the button. If the contact start position is inside the button, the contact termination position is inside or outside the button.

In FIG. 11, steps S68 and S69 are carried out in place of the step S6 shown in FIG. 2. The step S68 calculates the slide angle θ_{SI} from coordinates (x1, y1) of the contact start position Ss and coordinates (x2, y2) of the contact termination position St. FIG. 12 shows a case where the coordinates (x1, y1) of the contact start position Ss are inside the button, the coordinates (x2, y2) of the contact termination position St is outside the button, and the reference straight line is a horizontal line. The slide angle θ_{SI} may be calculated from θ_{SI}=arctan(y2−yl)/(x2−x1). The step S69 decides whether or not the slide angle θ_{SI} matches the slide angle θ_{SO} that is registered in advance. In this case, it is judged that the slide angle θ_{SI} matches the registered slide angle θ_{SO} if θ_{SI} satisfies a relationship (θ_{SO}−θt/2)≦θ_{SI}≦(θ_{SO}+θt/2) by using the tolerable error θt. If the decision result in the step S69 is NO, a process identical to the process that is carried out if the decision result in the step S6 shown in FIG. 2 is NO is carried out. On the other hand, if the decision result in the step S69 is YES, a process identical to the process that is carried out if the decision result in the step S6 shown in FIG. 2 is YES is carried out.

In general, the user is familiar with pushing a button, but is not familiar with making the slide operation by sliding the user's finger from outside the button to inside the button. Hence, by making the size of the button sufficiently large with respect to the average size of the finger tip (for example, finger tip of the index or middle finger) of adults, the slide operation from “inside the button”→“outside the button” at a predetermined slide angle can be made by pushing the button by the operator's finger and then sliding this finger on the button at the predetermined angle, thereby making it possible even for a user who is unfamiliar with the slide operation to easily make the slide operation.

Next, a description will be given of a button layout suited for the slide operation of the button, by referring to FIGS. 13 through 16. FIGS. 13 through 16 are diagrams for explaining the button layout suited for the slide operation of the button.

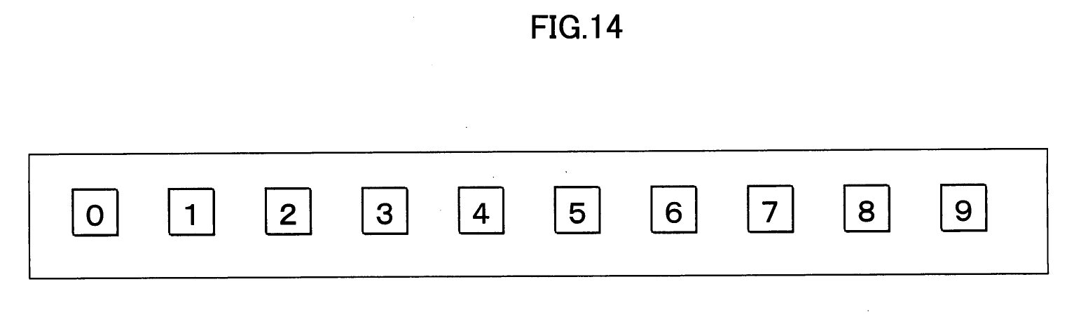

FIG. 13 shows numeric buttons arranged in a matrix arrangement, and FIG. 14 shows numeric buttons arranged in a row (or line). According to the button layouts of the numeric buttons shown in FIGS. 13 and 14, a distance between two mutually adjacent numeric buttons is set larger than the average size of the finger tip (for example, finger tip of the index or middle finger) of adults. For this reason, the button layouts of the numeric buttons shown in FIGS. 13 and 14 are suited for cases where the slide operation is made from “outside the button”→“inside the button”→“outside the button”, “outside the button”→“inside the button”, and “inside the button”→“outside the button”.

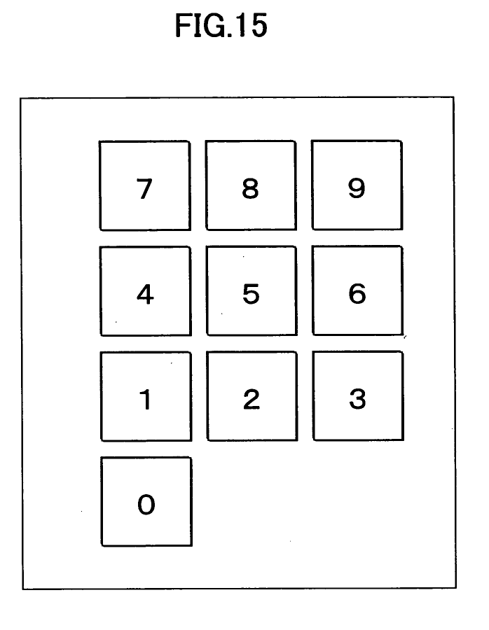

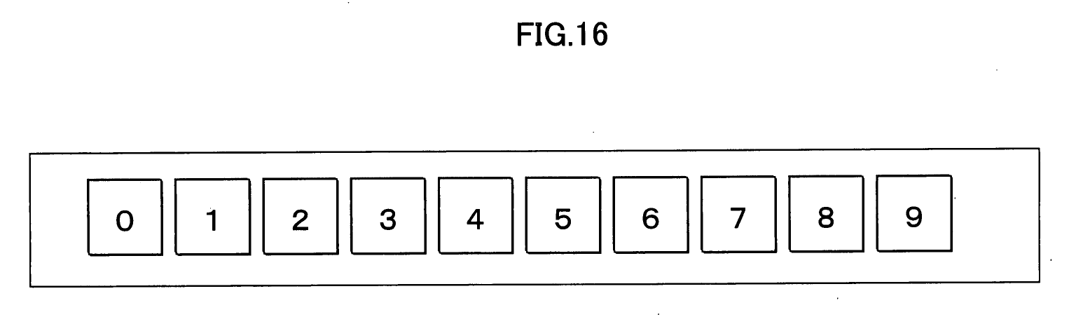

FIG. 15 shows numeric buttons arranged in a matrix arrangement, and FIG. 16 shows numeric buttons arranged in a row (or line). According to the button layouts of the numeric buttons shown in FIGS. 15 and 16, the size of the numeric buttons is set larger than the average size of the finger tip (for example, finger tip of the index or middle finger) of adults. For this reason, the button layouts of the numeric buttons shown in FIGS. 15 and 16 are suited for cases where the slide operation is made from “inside the button”→“outside the button”, and “inside the button”→“inside the button”.

Of course, the personal identification may be made based on a combination of the operation sequence of the plurality of buttons and the operation direction (or sliding direction) or the operation angle (sliding angle) in which the operator's finger is moved on the operation panel of the operation part 3.

In the embodiment described above, the buttons displayed on the display panel of the operation panel 3 are operated by the user's finger because the operation part 3 is formed by the touch panel. However, the slide operation with respect to the button may of course be made by use of a suitable jig.

In addition, instead of displaying the buttons on the display panel of the operation part 3, it is possible to provide in the operation panel of the operation part 3 a plurality of operation target regions that indicate the numerals, characters and/or symbols that are printed, for example. The operation target regions may be provided by being directly printed on the operation panel or, by being printed on a seal or the like that is adhered on the operation panel. In this case, the operation panel of the operation part 3 can be realized by a hardware sensor, such as a simple touch panel. Such a hardware sensor may be provided for each operation target region (or button) or, a single hardware sensor may be virtually divided into a plurality of regions corresponding to the plurality of operation target regions (or buttons) so as to detect the operation made by the user with respect to each divided region of the hardware sensor. When using the hardware sensor, the numerals, characters and/or symbols may be printed at the position of the corresponding hardware sensor or, a seal or the like having the numerals, characters and/or symbols printed thereon may be adhered at the position of the corresponding hardware sensor, so that the user may make an operation with respect to the operation target region similarly to the case using the buttons described above to input the personal identification number (or personal identification code).

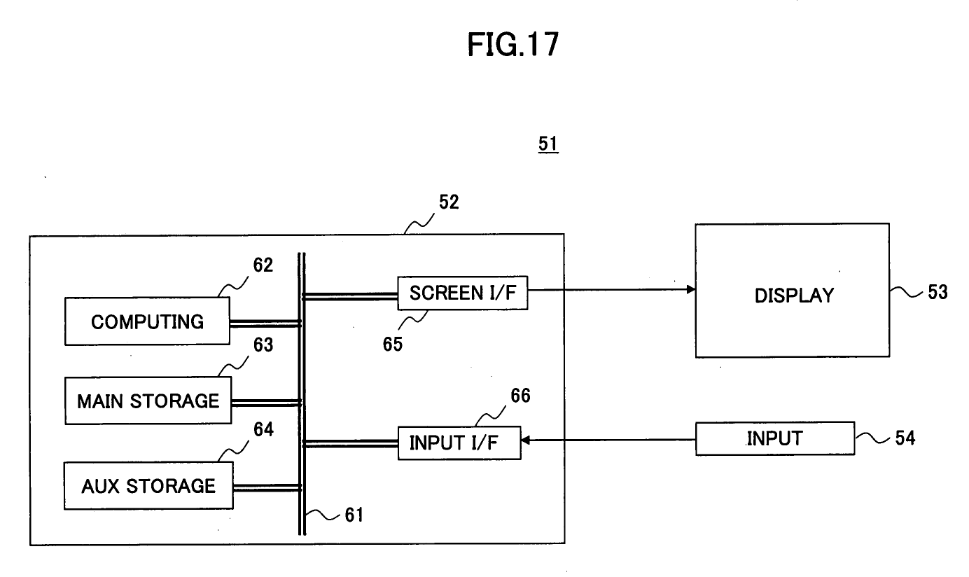

FIG. 17 is a system block diagram showing a second embodiment of the authentication apparatus according to the present invention. This second embodiment of the authentication apparatus employs a second embodiment of the authentication method according to the present invention and a second embodiment of the computer-readable storage medium according to the present invention. In this second embodiment of the authentication apparatus, the present invention is applied to a computer.

A computer 51 shown in FIG. 17 includes a main part 52, a display part 53 and an input part 54. The main part 52 includes a computing part (or processing part) 62, a main storage part 63, an auxiliary storage part 64, a screen interface (I/F) 65 and an input interface (I/F) 66 that are connected via a bus 61. The display part 53 is formed by a CRT, LCD, PDP or the like having a known structure. The input part 54 is formed by a keyboard, mouse or the like having a known structure. The computing part 52 is formed by a processor such as a CPU, and controls the operation of the entire computer 51. The main storage part 63 is formed by a storage unit such as a RAM, ROM and/or a disk unit, and stores computer programs that are executed by the computing part 62, intermediate data of computations carried out by the computing part 62, and the like. The auxiliary storage part 64 stores an authentication database that registers the user information (registered user information) in advance. The screen I/F 65 outputs information that is to be displayed on the display part 53, under the control of the computing part 62. The input I/F 66 inputs to the computing part 62 information that is input from the input part 54.

The internal structure itself of the computer 51 shown in FIG. 17 may be realized by a known structure or, by a structure of a known personal computer.

In this embodiment, the personal identification is made when the power of the computer 51 is turned ON, for example, and predetermined functions (or facilities) of the computer 51 become usable only when the personal identification is successful. The personal identification number of the user may be input by tracing the buttons displayed on the display part 53 by the mouse or the like of the input part 54, by an operation similar to the sliding operation employed in the first embodiment described above. Accordingly, the operation direction or the operation angle in this embodiment can be detected similarly to the first embodiment described above, and a detailed description thereof will be omitted.

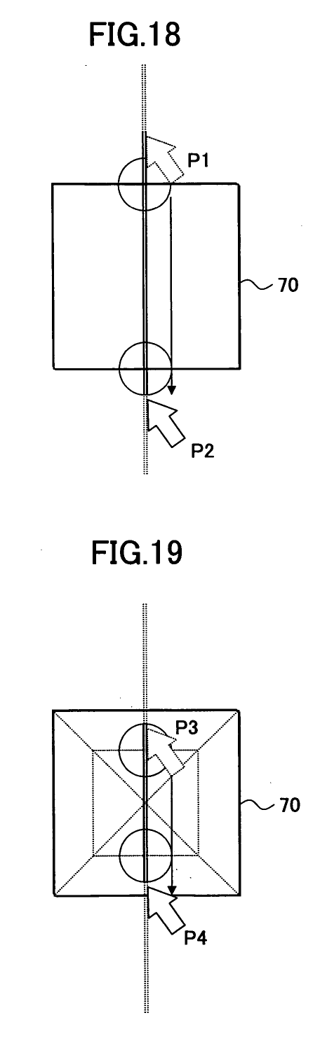

Next, a description will be given of a case where the button is traced by the cursor, by referring to FIGS. 18 through 23. FIGS. 18 through 23 are diagrams for explaining the case where the button is traced by the cursor.

FIG. 18 is a diagram for explaining a case where a button 70 is traced by the cursor from “outside the button”→“outside the button”from the top to bottom (top-to-bottom direction). In this case, it is assumed for the sake of convenience that the virtual polygon is a rectangle having the same size as the button 70. The user moves the cursor to a position P1 and makes a drag operation to drag the cursor to a position P2 as indicated by an arrow while maintaining the mouse in a clicked state, and unclicks the mouse at the position P2. Hence, an operation similar to the case where the slide operation is made from the top to bottom with respect to the button of the fourth digit “1” of the personal identification number in FIG. 3 as described above for the first embodiment is in effect made with respect to the button 70.

FIG. 19 is a diagram for explaining a case where the button 70 is traced by the cursor from “inside the button”→“inside the button” from the top to bottom (top-to-bottom direction). In this case, it is assumed for the sake of convenience that the virtual polygon indicated by the broken line is a rectangle having a size smaller than that of the button 70. The user moves the cursor to a position P3 and makes a drag operation to drag the cursor to a position P4 as indicated by an arrow while maintaining the mouse in the clicked state, and unclicks the mouse at the position P4. Hence, an operation similar to the case where the slide operation is made from the top to bottom with respect to the button of the fourth digit “1” of the personal identification number in FIG. 3 as described above for the first embodiment is in effect made with respect to the button 70.

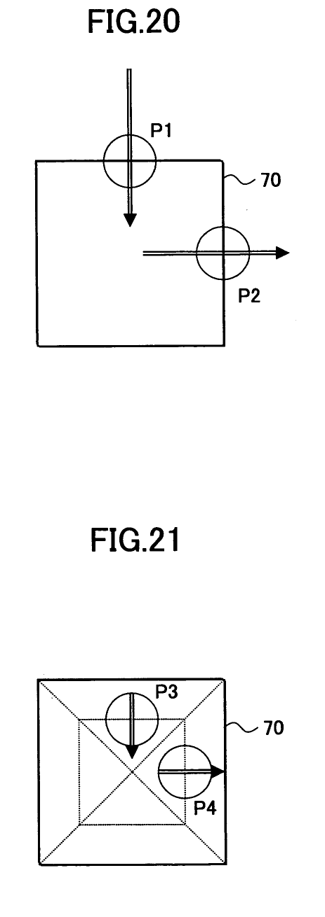

FIG. 20 is a diagram for explaining a case where the button 70 is traced by the cursor from “outside the button”→“outside the button” from the top to bottom (top-to-bottom direction) and then to the right. In this case, it is assumed for the sake of convenience that the virtual polygon is a rectangle having the same size as the button 70. The user moves the cursor to the position P1, changes the moving direction inside the button 70 and makes a drag operation to drag the cursor to the position P2 as indicated by an arrow, while maintaining the mouse in the clicked state, and unclicks the mouse at the position P2.

FIG. 21 is a diagram for explaining a case where the button 70 is traced by the cursor from “inside the button”→“inside the button” from the top to bottom (top-to-bottom direction) and then to the right. In this case, it is assumed for the sake of convenience that the virtual polygon indicated by the broken line is a rectangle having a size smaller than that of the button 70. The user moves the cursor to the position P3, changes the moving direction inside the button 70 and makes a drag operation to drag the cursor to the position P4 as indicated by an arrow, while maintaining the mouse in a clicked state, and unclicks the mouse at the position P4.

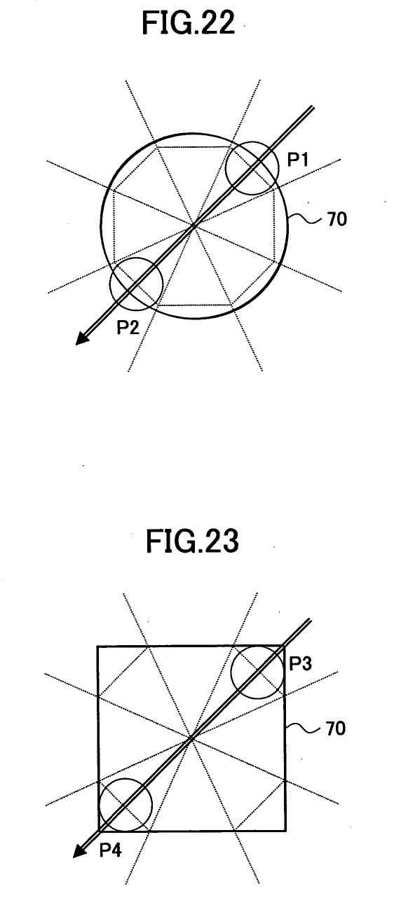

FIG. 22 is a diagram for explaining a case where the button 70 is traced by the cursor from “outside the button”−“outside the button” from the top right to the bottom left in an oblique direction. In this case, it is assumed for the sake of convenience that the virtual polygon indicated by the broken line is an octagon having approximately the same size as the button 70 which has a circular shape. The user moves the cursor to the position P1 and makes a drag operation to drag the cursor to the position P2 as indicated by an arrow while maintaining the mouse in the clicked state, and unclicks the mouse at the position P2.

FIG. 23 is a diagram for explaining a case where the button 70 is traced by the cursor from “inside the button”→“inside the button” from the top right to the bottom left in an oblique direction. In this case, it is assumed for the sake of convenience that the virtual polygon indicated by the broken line is an octagon having a size slightly smaller than that of the button 70 which has a rectangular shape. The user moves the cursor to the position P3 and makes a drag operation to drag the cursor to the position P4 as indicated by an arrow while maintaining the mouse in the clicked state, and unclicks the mouse at the position P4.

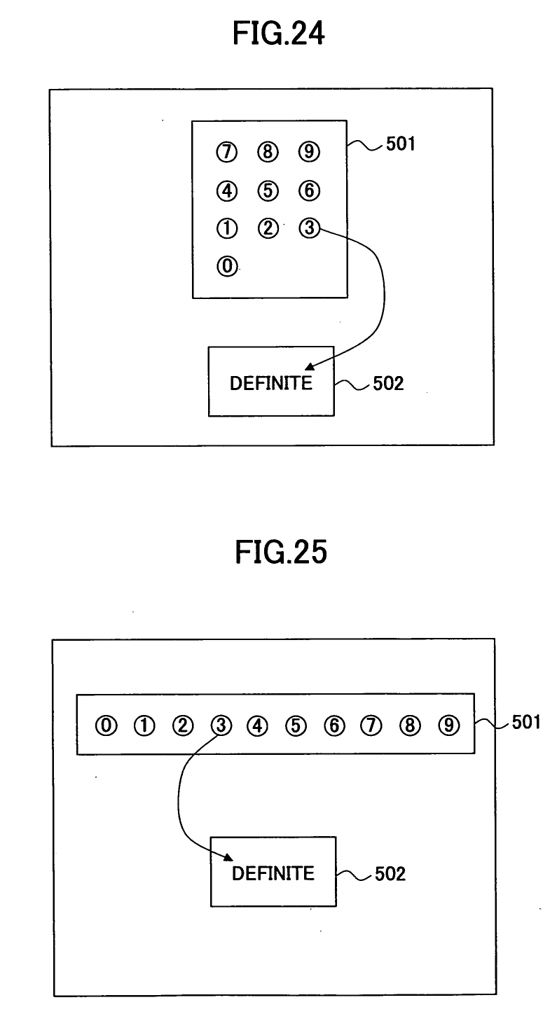

Next, a description will be given of a case where the operation direction of the button is determined by a drag-and-drop operation, by referring to FIGS. 24 and 25. FIGS. 24 and 25 are diagrams for explaining the case where the operation direction of the button is determined by the drag-and-drop operation.

FIG. 24 shows a key region 501 and a definite region 502 that are displayed on the screen of the display part 53. Buttons of a ten-key are displayed in the key region 501. The key region 501 has a polygonal shape, but the shape of the definite region 502 is not limited to a particular shape. The key region 501 has a function similar to that of the virtual polygon of the first embodiment described above. When the cursor is moved by the mouse of the input part 54 and the mouse is clicked on the button of the numeral “3”, for example, and the cursor is moved inside the definite region 502 by a drag-and-drop, the input of the numeral “3” becomes definite. When making this drag-and-drop operation, the operation direction with respect to the button is determined depending on which side of the key region 501 is passed. In other words, in the particular case shown in FIG. 24, the drag-and-drop with respect to the button of the numeral “3” is made by passing the right side of the key region 501, and thus, the operation direction with respect to the button of the numeral “3” is left-to-right. Accordingly, the operation direction with respect to the button in this case can be detected by the fifth slide direction detection process of the first embodiment described above. That is, it is possible to detect the operation direction by registering only the pass termination point STr of the key region 501 and matching the actual pass termination point ST with the registered pass termination point STr.

FIG. 25 shows a key region 501 and a definite region 502 that are displayed on the screen of the display part 53. Buttons of a ten-key are displayed in the key region 501. The definite region 502 has a polygonal shape, but the shape of the key region 501 is not limited to a particular shape. The definite region 502 has a function similar to that of the virtual polygon of the first embodiment described above. When the cursor is moved by the mouse of the input part 54 and the mouse is clicked on the button of the numeral “3”, for example, and the cursor is moved inside the definite region 502 by a drag-and-drop, the input of the numeral “3” becomes definite. When making this drag-and-drop operation, the operation direction with respect to the button is determined depending on which side of the definite region 502 is passed. In other words, in the particular case shown in FIG. 25, the drag-and-drop with respect to the button of the numeral “3” is made by passing the left side of the definite region 502, and thus, the operation direction with respect to the button of the numeral “3” is left-to-right. Accordingly, the operation direction with respect to the button in this case can be detected by the fourth slide direction detection process of the first embodiment described above. That is, it is possible to detect the operation direction by registering only the pass start point SSr of the definite region 502 and matching the actual pass start point SS with the registered pass start point SSr.

Only one definite region 502 is provided in FIGS. 24 and 25, but it is of course possible to provide a plurality of definite regions 502. For example, in the case shown in FIG. 24, four definite regions 502 may be provided adjacent to the four sides of the key region 501, so as to facilitate the drag-and-drop operation. In the case shown in FIG. 25, a plurality of definite regions 502 having different shapes may be provided, for example, so that a large number of operation directions can easily be realized by the drag-and-drop operation.

In each of the embodiments described above, the description is given for the case where the buttons are numeric buttons. However, the buttons are not limited to numeric buttons, because it is possible to use in place of the personal identification number a personal identification code that is made up of characters and/or symbols other than the numerals or, a combination of the numerals, characters and/or symbols. In other words, the buttons displayed on the operation panel of the operation part 3 or the display part 53 only need to include at least one kind of the numeric buttons, character buttons and symbol buttons. Moreover, it is not essential for the shapes of all of the buttons displayed on the operation panel of the operation part 3 or the display part 53 to be the same.

Each embodiment of the computer-readable storage medium stores a computer program for causing a computer to carry out the authentication shown in FIG. 2. A recording medium forming the computer-readable storage medium is not limited to a particular type, and any suitable recording media capable storing the computer program in a computer-readable manner may be used. Recording media usable for the computer-readable storage medium include magnetic recording media, optical recording media, magneto-optical recording media, semiconductor memory devices and the like. In addition, the computer program may be downloaded into the main storage part 23 from another computer via a network or the like. In FIGS. 1 and 17, it is assumed for the sake of convenience that the computer program is installed in the main storage part 23 or 63 in advance.

Further, the present invention is not limited to these embodiments, but various variations and modifications may be made without departing from the scope of the present invention.

What is claimed is:

1. An authentication method for making a personal identification when a plurality of operation target regions corresponding to a personal identification code are operated in a predetermined sequence, comprising:
a judging step judging whether or not a predetermined operation target region that is preset is operated in a preset operation direction or a preset operation angle; and
a confirming step confirming the personal identification based on a judgement result of the judging step.

2. The authentication method as claimed in claim 1, wherein the judging step detects the operation direction or the operation angle based on an operation start position and an operation termination position with respect to the predetermined operation target region.

3. The authentication method as claimed in claim 2, wherein the operation start position is located inside a region of an outer peripheral portion of the predetermined operation target region or inside a region of an internal portion of the predetermined operation target region, and the operation termination position is located inside a region of the outer peripheral portion of the predetermined operation target region or inside a region of the internal portion of the predetermined operation target region.

4. The authentication method as claimed in claim 2, wherein the judging step detects the operation direction or the operation angle based on a side of a virtual polygon that is preset with respect to the predetermined operation target region and is passed while moving from the operation start position to the operation termination position with respect to the predetermined operation target region.

5. The authentication method as claimed in claim 2, wherein the operation target regions are formed by a touch panel, and the preset operation direction or the preset operation angle is determined by a slide operation on the touch panel from the operation start position to the operation termination position with respect to the predetermined operation target region.

6. The authentication method as claimed in claim 2, wherein the operation target regions are formed by a display part, and the preset operation direction or the preset operation angle is determined by a drag operation on the display part from the operation start position to the operation termination position with respect to the predetermined operation target region.

7. The recognition method as claimed in claim 2, wherein:
the plurality of operation target regions are formed by a plurality of buttons displayed on a screen that is displayed on a display part,
the plurality of buttons are displayed inside a predetermined region of the screen,
a definite region, to which an arbitrary button is dragged and dropped by a drag-and-drop operation of a cursor when making definite a selection of the arbitrary button, is displayed outside the predetermined region of the screen, and
the preset operation direction of the arbitrary button is determined by the drag-and-drop operation of the cursor to drag and drop the arbitrary button into the definite region.

8. The authentication method as claimed in claim 7, wherein the predetermined region has a polygonal shape, and the judging step detects the operation direction based on a side of the predetermined region that is passed while moving from the operation start position to the operation termination position on the screen with respect to the arbitrary button.

9. The authentication method as claimed in claim 7, wherein the definite region has a polygonal shape, and the judging step detects the operation direction based on a side of the definite region that is passed while moving from the operation start position to the operation termination position on the screen with respect to the arbitrary button.

10. The authentication method as claimed in claim 1, wherein the confirming step confirms the personal identification depending on a combination of the operation sequence of the plurality of operation target regions and the operation direction or the operation angle, based on the judgement result of the judging step.

11. An authentication apparatus for making a personal identification when a plurality of operation target regions corresponding to a personal identification code are operated in a predetermined sequence, comprising:
a judging part configured to judge whether or not a predetermined operation target region that is preset is operated in a preset operation direction or a preset operation angle; and
a confirming part configured to confirm the personal identification based on a judgement result of the judging part.

12. The authentication apparatus as claimed in claim 11, wherein the judging part detects the operation direction or the operation angle based on an operation start position and an operation termination position with respect to the predetermined operation target region.

13. The authentication apparatus as claimed in claim 12, wherein the operation start position is located inside a region of an outer peripheral portion of the predetermined operation target region or inside a region of an internal portion of the predetermined operation target region, and the operation termination position is located inside a region of the outer peripheral portion of the predetermined operation target region or inside a region of the internal portion of the predetermined operation target region.

14. The authentication apparatus as claimed in claim 12, wherein the judging part detects the operation direction or the operation angle based on a side of a virtual polygon that is preset with respect to the predetermined operation target region and is passed while moving from the operation start position to the operation termination position with respect to the predetermined operation target region.

15. The authentication apparatus as claimed in claim 12, further comprising:
a touch panel forming the operation target regions,
wherein the preset operation direction or the preset operation angle is determined by a slide operation on the touch panel from the operation start position to the operation termination position with respect to the predetermined operation target region.

16. The authentication apparatus as claimed in claim 12, further comprising:
a display part forming the operation target regions,
wherein the preset operation direction or the preset operation angle is determined by a drag operation on the display part from the operation start position to the operation termination position with respect to the predetermined operation target region.

17. The recognition apparatus as claimed in claim 12, further comprising:
a display part configured to display a screen,
wherein the plurality of operation target regions are formed by a plurality of buttons displayed on the screen that is displayed on the display part,
the plurality of buttons are displayed inside a predetermined region of the screen,
a definite region, to which an arbitrary button is dragged and dropped by a drag-and-drop operation of a cursor when making definite a selection of the arbitrary button, is displayed outside the predetermined region of the screen, and
the preset operation direction of the arbitrary button is determined by the drag-and-drop operation of the cursor to drag and drop the arbitrary button into the definite region.

18. The authentication apparatus as claimed in claim 17, wherein the predetermined region has a polygonal shape, and the judging part detects the operation direction based on a side of the predetermined region that is passed while moving from the operation start position to the operation termination position on the screen with respect to the arbitrary button.

19. The authentication apparatus as claimed in claim 17, wherein the definite region has a polygonal shape, and the judging part detects the operation direction based on a side of the definite region that is passed while moving from the operation start position to the operation termination position on the screen with respect to the arbitrary button.

20. The authentication apparatus as claimed in claim 11, wherein the confirming part confirms the personal identification depending on a combination of the operation sequence of the plurality of operation target regions and the operation direction or the operation angle, based on the judgement result of the judging part.

21. A computer-readable storage medium which stores a computer program for causing a computer to make a personal identification when a plurality of operation target regions corresponding to a personal identification code are operated in a predetermined sequence, said computer program comprising:
a judging procedure causing the computer to judge whether or not a predetermined operation target region that is preset is operated in a preset operation direction or a preset operation angle; and
a confirming procedure causing the computer to confirm the personal identification based on a judgement result of the judging procedure.

22. The computer-readable storage medium as claimed in claim 21, wherein the judging procedure causes the computer to detect the operation direction or the operation angle based on an operation start position and an operation termination position with respect to the predetermined operation target region.

23. The computer-readable storage medium as claimed in claim 21, wherein the confirming procedure causes the computer to confirm the personal identification depending on a combination of the operation sequence of the plurality of operation target regions and the operation direction or the operation angle, based on the judgement result of the judging procedure.
